(19) United States
(12) Patent Application Publication
(10) Pub. No.: US 2021/0206075 A1
(43) Pub. Date: Jul. 8, 2021

(54) 3D PRINTER MATERIAL CARTRIDGE WITH INDICATOR

(71) Applicant: HEWLETT-PACKARD DEVELOPMENT COMPANY, L.P., Houston, TX (US)

(72) Inventors: Jeremy BARRIBEAU, Vancouver, WA (US); John ENNIS, Vancouver, WA (US); David C. HARVEY, Corvallis, OR (US); Adam L. HORNSTEIN, San Diego, CA (US)

(73) Assignee: HEWLETT-PACKARD DEVELOPMENT COMPANY, L.P., Houston, TX (US)

(21) Appl. No.: 16/074,570

(22) PCT Filed: Apr. 21, 2017
(86) PCT No.: PCT/US2017/028795

§ 371 Date: Aug. 1, 2018

(51) Int. Cl. B29C 64/255; B29C 64/291; B29C 64/112; B29C 64/307; B33Y 30/00; B33Y 40/00

(52) U.S. Cl. CPC B29C 64/255; B29C 64/291; B29C 64/112; B29K 2105/26; B33Y 30/00; B33Y 40/00; B29C 64/307

(57) ABSTRACT

A three-dimensional (3D) printer material cartridge for a 3D printer includes an indicator disposed on an exterior surface of the 3D printer material cartridge. The indicator colorant is responsive to energy from an energy source of the 3D printer. The indicator is a message that becomes visible in response to exposure of the colorant to the energy.

### BACKGROUND

Three-dimensional (3D) printing may produce a 3D object. In particular, a 3D printer may add successive layers of material under computer control to produce the 3D object. A 3D printer material cartridge may hold and supply the material to the 3D printer.

### DESCRIPTION OF THE DRAWINGS

Certain examples are described in the following detailed description and in reference to the drawings, in which:

FIG. 1A is a diagram of a 3D printer material cartridge having an indicator for fresh material before exposure of the indicator to an energy source in accordance with examples of the present techniques;

FIG. 1B is a diagram of a 3D printer material cartridge having an indicator after exposure of the indicator to an energy source in accordance with examples of the present techniques;

FIG. 2A is a diagram of a label having an indicator affixed to a 3D printer material cartridge for fresh material before exposure of the indicator to an energy source in accordance with examples of the present techniques;

FIG. 2B is a diagram of a label having an indicator applied to a 3D printer material cartridge after exposure of the indicator to an energy source in accordance with examples of the present techniques;

FIG. 3 is a diagram of a 3D printer that receives a 3D printer material cartridge in accordance with examples of the present techniques; and

FIG. 4 is a block flow diagram of a method for manufacturing a 3D printer material cartridge in accordance with examples of the present techniques.

### DETAILED DESCRIPTION

Techniques for communicating the status of a three-dimensional (3D) printer material cartridge are discussed herein. A 3D printer material cartridge may hold or contain material to be printed by the 3D printer to form a 3D object of the material. The material may be in powder form or other form. The material may be metal, plastic, polymer, glass, ceramic, or other material. As discussed below, the 3D printer material cartridge may supply or provide for the material to the 3D printer either directly or indirectly, e.g., via a material processing unit. Furthermore, as also discussed below, a 3D printer material cartridge for a 3D printer may include an indicator disposed on the exterior surface of the 3D printer material cartridge. The indicator may include colorant, ink, pigment, etc. responsive to energy, such as light or heat from a source, such as a light or heat source, of the 3D printer. The indicator may be a message that becomes visible in response to exposure of the indicator colorant to the light from the light source. The message may be or include a graphic or graphic indication. The change of the message from invisible to visible may be irreversible in certain examples.

Some existing 3D printers that reclaim and reuse powdered materials in the process of printing may have large, expensive, dedicated machines for storing, processing, and offloading reclaimed powdered material. The operators of these 3D printers may be highly trained. Alternatively, aftermarket storage buckets may be manually filled with reclaimed powdered material and then labeled by hand. Neither alternative may be desirable, for example, if the 3D printer is to be used by the general public. In contrast, examples of the 3D printer material cartridge discussed herein may be received by a 3D printer designed to be used by consumers of varying levels of ability.

In some instances, without the techniques discussed herein, users of this 3D printer may rely on the condition of, for example, a cap or similar component of the 3D printer material cartridge to determine the contents of the 3D printer material cartridge. A broken or released cap or lid may indicate that the 3D printer material cartridge is ready to receive recycled material or has received recycled material, and is to be employed as a recycled material cartridge, e.g., to receive and supply recycled material. However, a 3D printer material cartridge removed prior to the 3D printer consuming the cartridge's entire material fill may have a released cap, but would not yet be ready to receive recycled material. Hence, the condition of the material cartridge cap or similar component may be an unreliable indicator of the status of a 3D printer material cartridge. Furthermore, hand-marking of a 3D printer material cartridge to indicate its contents may also be unreliable. Hand-marking may involve workflow training and consistency across various users of the 3D printer. Multiple users of varying ability may be expected to use the 3D printer that receives the 3D printer cartridge. Workflow training of most or all users and consistency across most or all users of the 3D printer may not be efficiently achievable. Thus, reliance on hand-marking or other user-markings may be problematic.

Certain examples of a 3D printer designed to receive the 3D printer material cartridge discussed herein may have one or multiple material cartridge slots. In particular examples, the 3D printer may have two slots: one for “fresh” material and a second for “recycled” material. Other examples may have more than two slots for material cartridges, or a single slot for a material cartridge. The new or fresh material slot may hold a printer material cartridge that supplies or otherwise provides material to the 3D printer for printing of the 3D object. In contrast, the recycled material slot may hold a printer material cartridge that receives material from the 3D printer. The material entering the printer material cartridge in the recycled material slot may be surplus material left over or otherwise not used in the printing of the 3D object. When a fresh material cartridge is fully depleted, e.g., when the 3D printer has consumed the cartridge's contents, the material cartridge may be removed by the user and re-purposed for later use in the recycled material slot. In one example, the empty cartridge as a recycled material cartridge in a slot or in a recycled material slot may receive unused powder from the printer during and/or at the conclusion of a print job. The cartridge in the recycled material slot when filled with recycled material may then supply or otherwise provide recycled material for printing including for the next print job in some examples. Yet again, other examples of 3D printers may have multiple slots for material cartridges.

User removal of the depleted fresh material cartridge may generally occur soon or immediately after depletion, so the 3D printer can be replenished with more fresh material. However, the re-installation or re-use of the empty and now “recycled” cartridge may not occur for some time. In other words, the user may retain this recycled cartridge for future use. Indeed, the user may store many of the empty recycled cartridges. The 3D printer may request the user re-install an empty recycled cartridge in a slot or the recycled material slot. Moreover, multiple material types may be employed by a 3D printer and therefore labels, markings, additional indicators, or other techniques may facilitate accounting of recycled material type in the recycle cartridges or containers.

As indicated, a purpose of the recycled material cartridge and any associated slot in the 3D printer may be to receive excess material from the 3D printer generated during the print process and therefore facilitate clean and contained offloading of excess material generated during the print process. In other words, a recycled cartridge in the single slot or the second slot of the 3D printer may receive excess material from the 3D printer during or after printing. Full recycled cartridges may concurrently supply recycled material or remain in the slot to provide recycled material, or be removed for future use, and the like. Some of these cartridges full of recycled material may remain in place or be discarded. Some of these recycled cartridges filled with recycled material may be removed and kept for future use such as when the 3D printer is short of recycled material, e.g., when the recycled material may be mixed with fresh material and consumed during printing. In certain examples of a 3D printer with only a single slot for a material cartridge, a fresh material cartridge (e.g., new powder container) may be inserted in the slot and have the contents thereof emptied into, for instance, an internal hopper. The cartridge could then become a recipient for recycled material (e.g. receive recycled powder either directly or filled from an internal recycled powder hopper, and the like).

The aforementioned indicator on the material cartridge may be formed in certain colorants, inks, pigments, or the like, to differentiate between fresh and recycled 3D printer material cartridges. In some examples, a colorant or colorants may include ink, pigments, or other coloring components. To form the indicator, the colorant may be printed on the body (e.g., plastic body) of a material cartridge or printed on a label that is applied to the material cartridge. The indicator colorant may be printed on the label before or after the label is affixed to the material cartridge. The colorant may react when exposed to energy from an energy source. For example, the energy may be light or heat from an energy source that is one or more light or heat sources. The energy source (e.g., light source, heat source, heat lamp, etc.) may be a component of the 3D printer. Examples of a light source that may be so employed include light emitting diodes (LEDs), halogen lamps, fluorescent lamps, mercury-arc lamps, or other types of light sources.

The indicator colorant may be responsive to a certain type or band of light provided by the light source. For example, the indicator colorant may be responsive to ultraviolet light or a narrow band of ultraviolet light. In a particular example, the indicator colorant is responsive to an ultraviolet wavelength of 254 nanometers (nm) and the printer light source emits a light band containing a wavelength of 254 nm. The target wavelength(s) of light may be determined by chemical design of the colorant. Examples of colorants or colorant chemicals that may be employed include photochromic dyes or pigments ordinarily employed to indicate irradiation by germicidal ultraviolet light. Examples of photochromic compounds include spirooxazine, spiropyran, fulgide, salicylidene, azobenzene, and so forth. Fortunately, some examples of photochromic colorants may not be inadvertently activated by exposure to sunlight or interior lighting. Other types of colorants may be utilized.

Before exposure to the light, the printed indicator colorant may be perceived as invisible, e.g., the colorant may be transparent or color-matched to the plastic body of the underlying material cartridge. After exposure to light or heat, the printed colorant may become visible (e.g., as a relatively high-contrast color indicator). The indicator may be a word, icon, color block, or other type of visual message indicating that the cartridge is substantially depleted of fresh material and ready to receive recycled material or already contains recycled material. The 3D printer designed to employ the material cartridge may have a light source that generates and discharges the band of light to which the colorant is responsive for the indicator to become visible. In a particular example, such a light source discharges a narrow band of ultraviolet light containing a wavelength of 254 nm. The light or heat source may be located in the 3D printer so that the light or heat impinges on the light- or heat-sensitive colorant when the light or heat source is activated. As discussed, the light- or heat-sensitive colorant that forms the indicator may be printed on the material cartridge or on a label applied to the material cartridge, and the like. Alternatively, the light- or heat-sensitive colorant, for example, as a pigment, may be added during molding of the material cartridge itself. Consequently, the entirety or a portion of the plastic body of the material cartridge may change color when exposed to light of the appropriate wavelength.

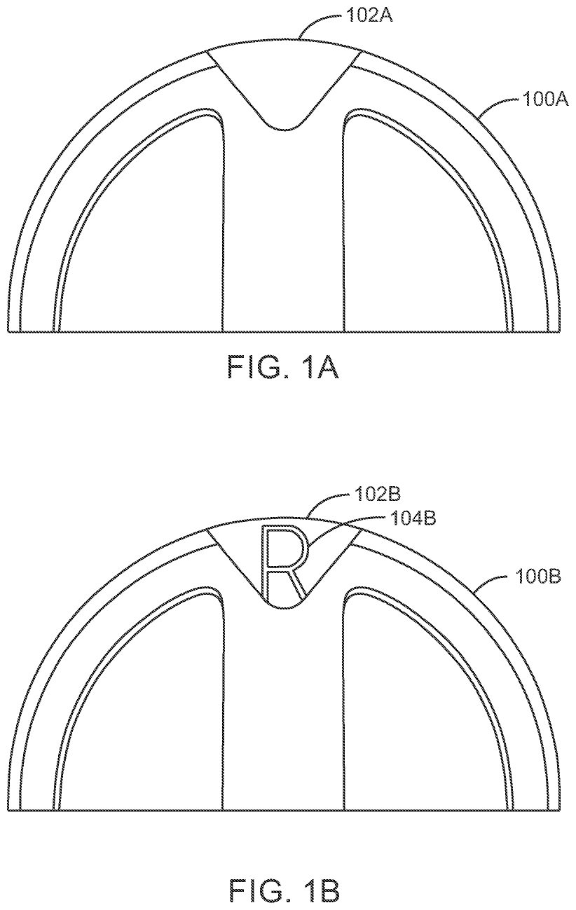

FIG. 1A is a diagram of a 3D printer material cartridge 100A for fresh material. The material cartridge 100A is to hold and supply material for use by a 3D printer. The material cartridge 100A may contain fresh material or be in production to be filled with fresh material. The cartridge 100A has an indicator colorant applied to an area 102A of the 3D printer material cartridge 100A. The indicator colorant may be sensitive or responsive to a band of wavelengths from a particular light source(s). The indicator colorant may be invisible because the area 102A has not yet been exposed to light from a specified light source, and the 3D printer material cartridge 100A is for fresh material. The indicator colorant may become visible after exposure to the specified light source. For example, after the 3D printer material cartridge 100A is depleted of fresh material, a light source inside the 3D printer may be activated. The light source may generate wavelengths of light to which the indicator colorant is reactive or sensitive, or otherwise responsive. In a particular example, the light source may generate a narrow band of ultraviolet light containing a wavelength of 254 nm or other wavelength, and the indicator colorant becomes visible when exposed to the light.

FIG. 1B is a diagram of a 3D printer material cartridge 100B after exposure of the area 102B to light or heat. Thus, the indicator 104B becomes visible. In some examples, after exposure of the area 102B to light or heat, the indicator 104B becomes irreversibly visible.

In one example, the light is a narrow band of ultraviolet light generated by the light source inside the associated 3D printer that holds the cartridge 100B and receives a supply of material from the cartridge 100B. Again, the colorant may be visible in the area 102B because the colorant may have been exposed to the specified light source (e.g., ultraviolet light having a wavelength of 254 nm or other wavelength). In the illustrated example, an “R” 104B printed in the area 102B in the colorant may become visible. Text or symbols other than “R” may be employed. The “R” 104B may indicate that the 3D printer material cartridge 100B is depleted of fresh material and is ready to receive recycled material. As mentioned, the change of the “R” 104B from the invisible state to the visible state may be irreversible. Further, the cartridge 100B may then receive recycled material. The cartridge 100B filled with recycled material may be stored or reused with the indicator “R” 104B indicating that the cartridge 100B was depleted of fresh material and now contains recycled material.

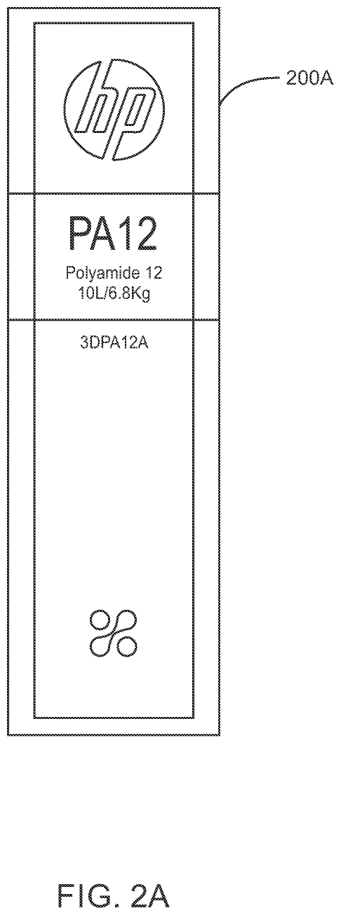

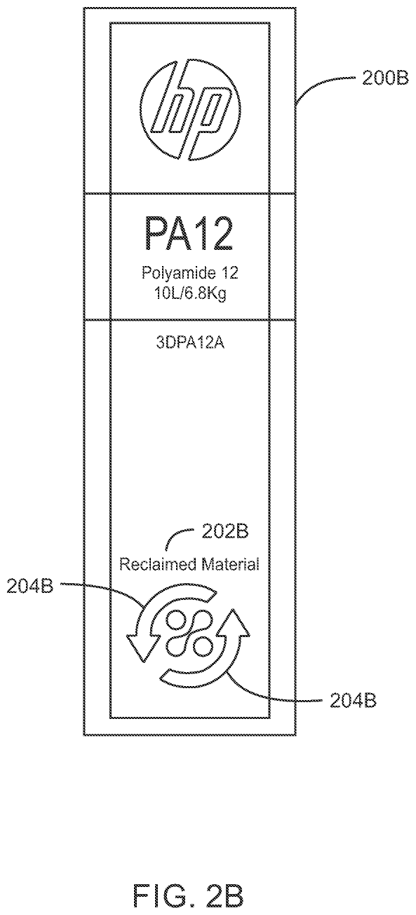

FIG. 2A is a diagram of a label 200A having an indicator printed thereon. The label 200A is affixed to a 3D printer material cartridge such as to an external surface of the 3D printer material cartridge. In the illustrated example, the 3D printer material cartridge may contain fresh material. The label 200A may be printed in the indicator colorant, but the colorant is invisible because the 3D printer material cartridge has not been exposed to energy such as light or heat. Indeed, the 3D printer material cartridge may still contain fresh material. Once the 3D printer material cartridge is depleted of material, an energy source such as a light source and/or heat source inside the 3D printer may be activated to expose the label 200 to the light or heat. In some examples with a light source employed, the light source may generate a band of ultraviolet light.

FIG. 2B is a diagram of a label 200B applied to the 3D printer material cartridge after exposure to the band of ultraviolet light generated by the light source inside the 3D printer. The indicator colorant may be visible because the colorant may have been exposed to ultraviolet light (e.g., having a wavelength of 254 nm). In the illustrated example, text that reads “Reclaimed Material” 202B and the recycle icon 204B printed in the indicator colorant may be visible. Other text may be employed. The text 202B and recycle icon 204B may indicate that the 3D printer material cartridge 200B is available to receive recycled material. The change of the text 202B and recycle icon 204B from the invisible state to the visible state may be irreversible.

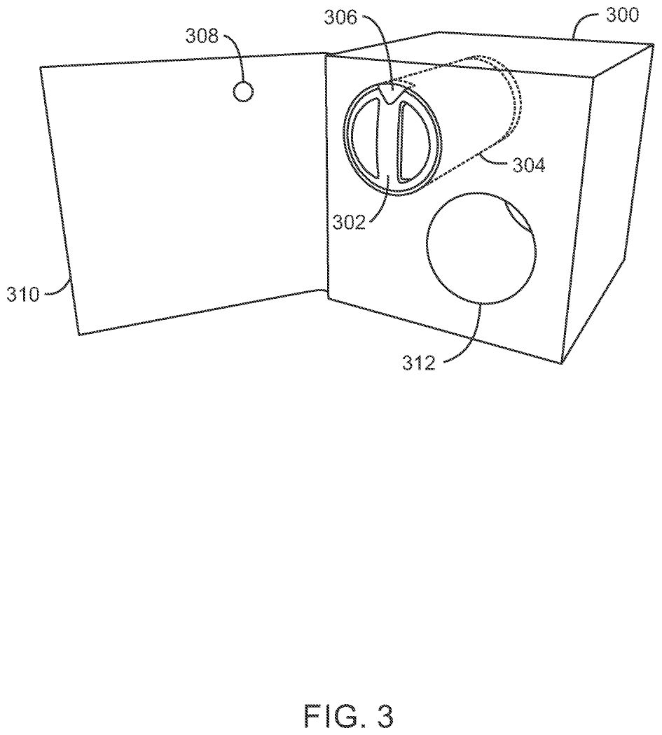

FIG. 3 is a diagram of a 3D printer 300 that receives a 3D printer material cartridge 302. Only a portion of the 3D printer is depicted for clarity. The 3D printer may include multiple subsystems arranged around a print zone. One of the subsystems may contain slots which accept material cartridges. For example, the content of a material cartridge is dispensed and conveyed to a location where the content or material is used by the print subsystem to generate a 3D printed object.

The 3D printer 300 may include a first slot 304 that accepts a 3D printer material cartridge 302 containing fresh material. The 3D printer 300 may be configured to receive fresh material from the material cartridge 302 with the material cartridge 302 positioned in the first slot 304. Indeed, in operation, as the 3D printer 300 prints a 3D object, the cartridge 302 in the first slot 304 supplies or provides the fresh material to the printer 300.

An indicator 306 may be printed on an external surface of the 3D printer material cartridge 302. Yet, the indicator 306 may be invisible because the 3D printer material cartridge 302 contains fresh material for use in 3D printing. The 3D printer 300 may also include an energy source 308 (e.g., light source, heat source, etc.) to expose the indicator 306 to energy (e.g., light, heat, etc.) when the cartridge 302 in the first slot 304 becomes depleted of material.

FIG. 3 shows the 3D printer 300 with its front 310 open. When the front 310 is closed, the energy source 308 may be brought into proximity or pointed in the direction of the indicator 306. Thus, with the front 310 closed, and the energy source 308 activated (e.g., in response to depletion of the cartridge 302), the printer 300 may expose the indicator 306 to the energy generated or provided by the energy source 308. If a light source is employed, the light may be ultraviolet light or other bands of light. In some examples with the energy source 308 as a light source, the light source may be a light emitting diode (LED), a halogen lamp, a fluorescent lamp, or a mercury-arc lamp, or any combinations thereof, or other types of light sources.

The 3D printer 300 is shown with one energy source 308 and the 3D printer material cartridge 302 is shown with one area 306 of indicator colorant to communicate the change from fresh material to recycled material. Additional information may be conveyed by exposing additional areas of indicator colorant to additional energy sources in different locations in the 3D printer 300. For example, when exposed to an additional light or heat source in a different location, an additional area of indicator colorant may become visible and convey that the material cartridge has reached its end-of-life or expiration date, and so on.

The 3D printer 300 may also include a sensor (not shown) to detect depletion of the fresh material in the 3D printer material cartridge 302. When depletion has occurred, the printer 300 may activate the energy source 308. The energy source 308 as a light source may expose the indicator 306 to the specified band of wavelengths (e.g., a band of infrared light or ultraviolet light). In those particular examples, once the indicator 306 is exposed to the specified band of wavelengths, the indicator 306 may become irreversibly visible indicating that the 3D printer material cartridge 302 is depleted or substantially depleted of fresh material, and is available to receive recycled material or that the material cartridge has received recycled material. In one example, when visible, the indicator 306 may be an “R” as shown in FIG. 1B.

The 3D printer 300 may further include a second slot 312. The second slot 312 may accept the 3D printer material cartridge 302 after the 3D printer material cartridge 302 has been depleted of fresh material and is available to receive recycled material. A 3D printer material cartridge 302 containing fresh material may be inadvertently inserted into the second slot 312 of the 3D printer 300. Likewise, a 3D printer material cartridge 302 containing recycled material may be inadvertently inserted into the first slot 304 of the 3D printer 300. In some examples, other indicators or components of the 3D printer material cartridge 302 in addition to the indicator 306 may note, indicate, or imply whether the 3D printer material cartridge 302 contains fresh or recycled material. Consequently, in some of those examples, the 3D printer 300 may generally prevent or reduce the occurrence of withdrawing material from the recycled cartridge unintentionally or inadvertently inserted into the first slot 304, and also generally prevent or reduce occurrence of adding material to or removing material from the fresh cartridge unintentionally or inadvertently inserted into the second slot 312.

In certain examples, the 3D printer 300 may be an additive manufacturing (AM) 3D printer to be employed in 3D printing to make solid 3D objects from a digital model or 3D model. In some examples, the model may be “sliced” in preparation for the layer-by-layer printing. The printer may build a component or product in layers by depositing material. A range of different metals, plastics, and composite materials may be used. Unlike subtractive manufacturing techniques (e.g., milling) that start with a solid block of material and then cut away the excess to create a finished part, AM may build a part (or components of a part) layer-by-layer from geometry described in a 3D design model. The 3D printer may print (fabricate) the product. Each of the layers can be seen as a thinly sliced horizontal cross-section of the eventual object. There are different 3D printing technologies and materials but most employ a digital model to generate a solid 3D physical object by adding material layer-by-layer. During the printing, the layers may be deposited, fused, melted, etc.

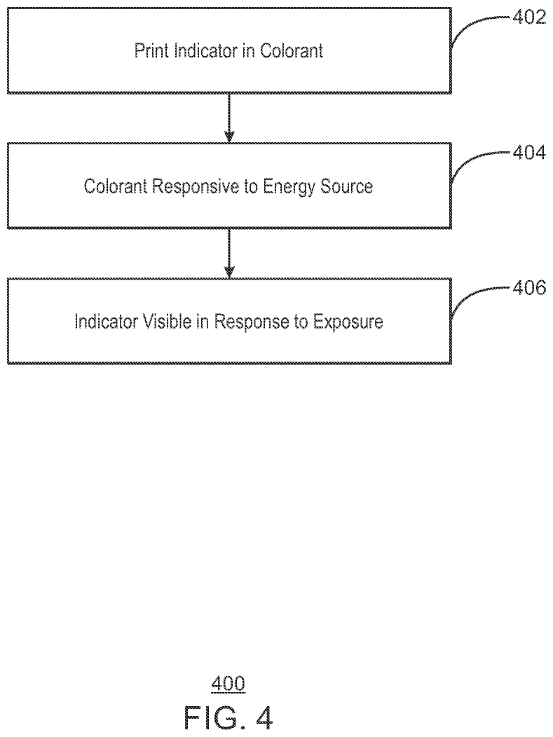

FIG. 4 is a block flow diagram of a method 400 for manufacturing a 3D printer material cartridge. At block 402, an indicator may be printed in light-sensitive colorant (e.g., energy-sensitive coloring components, pigments, ink or including ink, etc.) on a 3D printer material cartridge. Depending on the implementation, the indicator colorant may be printed directly on an exterior surface of the material cartridge, or on a label (e.g., a paper label, plastic label, etc.) to be applied to the material cartridge, and the like.

The colorant may be responsive to an energy source of the 3D printer, as noted in block 404. Indeed, with a light source as the energy source, the indicator colorant may be sensitive to or reactive with a particular type of light or a certain range of wavelength of light, and the like. In operation, the indicator may become visible in response to exposure of the colorant to the energy source, as referenced in block 406.

The indicator may be initially invisible without exposure to the energy source. The invisible indicator may facilitate indication of the 3D printer material cartridge as containing fresh material. When visible, the indicator may indicate that the 3D material cartridge is substantially depleted of fresh material and is available to receive recycled material or has received recycled material.

Some examples of a method of using a 3D printer material cartridge having the above-discussed indicator may involve inserting the cartridge containing fresh material into a first slot of a 3D printer. When the cartridge is depleted of fresh material, the empty cartridge may be removed from the first slot and discarded, stored, or inserted into a second slot of the 3D printer. Once inserted into the second slot, the empty cartridge may receive recycled material. The user or 3D printer may know to switch the 3D printer material cartridge from the first slot to the second slot when the indicator on the cartridge becomes visible.

In summary, an example is a 3D printer material cartridge for a 3D printer, the 3D printer material cartridge including an indicator located on an exterior surface of the 3D printer material cartridge. The indicator is printed in an ink responsive to light from a light source located in the 3D printer. The indicator may be a message that becomes visible in response to exposure of the ink to the light from the light source. The indicator may be printed on the exterior surface of the 3D printer material cartridge or on a label affixed to the exterior surface of the 3D printer material cartridge. In either case, the message may become visible (e.g., irreversibly visible) in response to exposure of the ink to the light from the light source. The 3D printer material cartridge may be a container for holding material for printing of a 3D object by the 3D printer. The light source may be one or more LEDs such as an ultraviolet LED. The light source may also be a halogen lamp, a fluorescent lamp, or a mercury-arc lamp, or any combinations thereof. When invisible, the indicator generally facilitates indication of the 3D printer material cartridge as containing fresh material in certain examples. When visible, the indicator may indicate that the 3D printer material cartridge is substantially depleted of the fresh material and is available to receive recycled material.

Another example is a 3D printer including a first slot to receive a 3D printer material cartridge containing fresh material for printing of a 3D object. An indicator is located on an exterior surface of the 3D printer material cartridge. The 3D printer also includes a light source disposed to expose the indicator to light when the light source is turned on or activated. The 3D printer further includes a sensor to detect depletion of the fresh material in the 3D printer material cartridge. Sensor types and techniques to detect fill level and subsequent depletion of a fresh material cartridge may include a strain gauge to determine weight, a rotary pneumatic dosing mechanism to perform volumetric measurements, and computational approximation of withdrawn material for a given 3D print job. Other sensor types and techniques for determining depletion of the fresh material cartridge may be applicable. The 3D printer operates the light source to expose the indicator to light in response to the depletion detected by the sensor. The indicator on the 3D printer material cartridge becomes visible (e.g., irreversibly visible) in response to exposure to the light from the light source. The light from the light source may be ultraviolet light. The light source may be a light emitting diode (LED). The 3D printer has a second slot to receive the 3D printer material cartridge after the 3D printer material cartridge is depleted of the fresh material and has received recycled material.

Yet another example is a computer-readable medium that may contain code to execute the indication of the status of a 3D printer material cartridge. The medium may be a non-transitory computer-readable medium that stores code that can be accessed by a processor via a bus. For example, the computer-readable medium may be a volatile or non-volatile data storage device. The medium may also be a logic unit, such as an application-specific integrated circuit (ASIC), a field-programmable gate array (FPGA), or an arrangement of logic gates implemented in one or more integrated circuits.

The medium may store modules or code (e.g., instructions, logic, etc.) executable to facilitate the techniques described herein. For example, an “off” module may be configured to keep an energy source (e.g., a light source, heat source, etc.) inside a 3D printer turned off when material is present in the 3D printer material cartridge. Because the energy source is turned off, a message printed on the 3D printer material cartridge itself or on a label affixed to the material cartridge may be invisible. The invisible message may indicate that the 3D printer material cartridge contains fresh material. An “on” module may be configured to turn on the energy source inside the 3D printer when the material in the 3D printer material cartridge is depleted. Once the energy source is turned on, the message printed on the 3D printer material cartridge itself or on a label affixed to the material cartridge may become visible. The visible message may indicate that the 3D printer material cartridge is available to receive recycled material. The change of the message from invisible to visible may be irreversible.

Certain examples of the techniques discussed herein may result in the use of fewer machines (e.g., a single machine) for 3D printing as compared to the use of several machines with existing 3D printers. Existing 3D printers may use large, expensive, dedicated machines for storing, processing, and offloading recycled powdered material. Because of some examples of the present techniques, the handling of recycled powdered material may be contained and, therefore, generally cleaner. Furthermore, the 3D printer material cartridges discussed herein may entail less expertise and less intervention by the user.

In some examples described herein, the functions of the 3D printer material cartridges and the actions taken by an end-user may be implicit in the design of the cartridges and recognized by the end-user. For example, there are a number of material cartridge functions, or states, which may be addressed and communicated by the indicator discussed herein. In particular, the same material supply is used first as a fresh supply and then re-purposed as a recycled supply. The recycled supply is used to load recycled material into the system when there is a recycled material deficit and offload recycled material from the system when there is a recycled material surplus. Empty fresh material cartridges, e.g., recycled material cartridges, should be kept for a period of time. Empty recycled and full recycled material cartridges will ultimately be discarded as appropriate. Material cartridges are specific to a single material type and cannot be mixed with or re-purposed for another material. Some material cartridges may be refillable using the 3D printer discussed herein. Other material cartridges may be refilled employing, for example, an accessory machine, and the like.

Some examples discussed herein make it possible for an end-user to identify and differentiate the various states of material cartridges, both when the material cartridges are installed in a 3D printer and when shelved in storage awaiting future use. Relatively quick and easy differentiation between fresh and recycled material cartridges may be afforded by the distinct visual difference between the two states of the cartridges. The visual difference may reinforce the function of the two material cartridge slots in a 3D printer. One slot may be dedicated to fresh material cartridges, while the other slot is dedicated to recycled material cartridges. The visual difference may also reinforce an understanding of the 3D printer's architecture as it pertains to material handling. This differentiation between fresh and recycled material cartridges may also save the user time and frustration when a material supply intervention is requested by the 3D printer's user interface. Installation of a material cartridge in the wrong slot may be physically possible, but the material cartridge may be rejected by the 3D printer's firmware after installation is complete.

While the present techniques may be susceptible to various modifications and alternative forms, the examples discussed above have been shown by way of example. It is to be understood that the technique is not intended to be limited to the particular examples disclosed herein. Indeed, the present techniques include all alternatives, modifications, and equivalents falling within the scope of the present techniques.

What is claimed is:

1. A three-dimensional (3D) printer material cartridge for a 3D printer, the 3D printer material cartridge comprising an indicator disposed on an exterior surface of the 3D printer material cartridge, the indicator comprising colorant responsive to energy from an energy source of the 3D printer, wherein the indicator comprises a message that becomes visible in response to exposure of the colorant to the energy.

2. The 3D printer material cartridge of claim 1, wherein the indicator comprises the colorant printed on the exterior surface of the 3D printer material cartridge, and wherein the message becomes irreversibly visible in response to exposure of the colorant to the energy.

3. The 3D printer material cartridge of claim 1, wherein the indicator comprises the colorant printed on a label disposed on the exterior surface of the 3D printer material cartridge, and wherein the message becomes irreversibly visible in response to exposure of the colorant to the energy.

4. The 3D printer material cartridge of claim 1, wherein the colorant comprises ink, wherein the 3D printer material cartridge comprises a container for holding material for printing of a 3D object by the 3D printer, wherein the energy source comprises a light source, and wherein the indicator facilitates indication of the 3D printer material cartridge containing fresh material when the message is invisible.

5. The 3D printer material cartridge of claim 1, wherein the energy source comprises a light source comprising an ultraviolet light emitting diode (LED), and wherein the energy comprises ultraviolet light.

6. The 3D printer material cartridge of claim 1, wherein the energy source comprises a light source comprising a light emitting diode (LED), a halogen light source, a fluorescent light source, or a mercury-arc light source, or any combination thereof, and wherein the message, when visible, indicates that the 3D printer material cartridge is substantially depleted of the fresh material and is available to receive recycled material or contains recycled material.

7. A three-dimensional (3D) printer, comprising:
a first slot to receive a 3D printer material cartridge for containing fresh material for printing of a 3D object, wherein an indicator is disposed on an exterior surface of the 3D printer material cartridge; and
a light source disposed to expose the indicator to light.

8. The 3D printer of claim 7, comprising a sensor to detect depletion of the fresh material in the 3D printer material cartridge, wherein the 3D printer to operate the light source to expose the indicator to light in response to the depletion, and wherein the indicator becomes irreversibly visible in response to exposure to the light.

9. The 3D printer of claim 7, wherein the light comprises ultraviolet light.

10. The 3D printer of claim 7, wherein the light source comprises a light emitting diode (LED).

11. The 3D printer of claim 7, comprising a second slot to receive the 3D printer material cartridge after the 3D printer material cartridge is depleted of the fresh material.

12. A method of manufacturing a three-dimensional (3D) printer material cartridge, comprising printing an indicator in colorant for the 3D printer material cartridge, wherein the colorant is responsive to energy from an energy source of the 3D printer, and wherein the indicator becomes visible in response to exposure of the colorant to the energy.

13. The method of claim 12, wherein the colorant comprises ink, wherein printing an indicator comprises printing the indicator in the colorant on an exterior surface of the 3D printer material cartridge, and wherein the indicator becomes irreversibly visible in response to exposure of the ink to the energy.

14. The method of claim 12, comprising applying a label to an exterior surface of the 3D printer material cartridge, wherein printing an indicator comprises printing the indicator in the colorant on the label, wherein the indicator becomes irreversibly visible in response to exposure of the colorant to the energy, wherein the energy comprises light, and wherein the energy source comprises a light source.

15. The method of claim 12, wherein the indicator is initially invisible without exposure to the energy, wherein the indicator, when invisible, facilitates indication of the 3D printer material cartridge as containing fresh material, wherein the indicator remains visible after exposure to the energy, and wherein the indicator, when visible, indicates the 3D printer material cartridge is substantially depleted of the fresh material and is available to receive or has received recycled material.
